(19) United States
(12) Patent Application Publication
(10) Pub. No.: US 2008/0075806 A1
(43) Pub. Date: Mar. 27, 2008

(54) Carrier Formulation

(75) Inventors: Tillmann Dorr, Hohen-Sulzen (DE); Lutz Guderjahn, Offstein (DE); Stephan Hausmanns, Wiesbeden (DE); Jorg Kowalczyk, Eisenberg/Steinborn (DE)

Correspondence Address: HARNESS, DICKEY & PIERCE, P.L.C., P.O. BOX 828, BLOOMFIELD HILLS, MI, 48303, US

(73) Assignee: Sudzucker Aktiengesellschaft Mnnheim/Ochsenfurt, Mannheim (DE)

(21) Appl. No.: 11/666,701

(22) PCT Filed: Oct. 28, 2005
(86) PCT No.: PCT/EP05/11559

§ 371 Date: Jun. 12, 2007

(30) Foreign Application Priority Data
Oct. 30, 2004 (DE) 10 2004 052 800.4

(51) Int. Cl. A23L 1/09; A23L 1/236; A23L 1/307

(52) U.S. Cl. 426/64; 426/386

(57) ABSTRACT

The present invention relates to dry aroma formulations containing a carrier-supported extract, in particular an extract carrier-supported on trehalose and/or isomaltulose as carrier, as well as methods for their production and uses thereof.

The present invention relates to dry aroma formulations containing a carrier-supported extract, in particular an extract carrier-supported on a non-laxative, tooth-preserving sugar as carrier, as well as methods for their production, and uses thereof.

Granulated beverages, for example granulated instant teas, very frequently contain sucrose as carrier. However, it has been shown that these products are associated with great disadvantages. It has been shown in numerous studies that the consumption of sucrose-containing instant teas can lead to considerable dental damage. For example, Nursing Bottle Syndrome (NBS) which occurs in babies and infants, and is characterized by carious and periodontal damage to the milk teeth, pathological changes of the microbial spectrum of the oral cavity, and chronic inflammation of the oral mucosa and alveolar jaw bone, is principally due to long-term sucking on pacifier bottles containing sucrose-containing instant teas (see, for example, Behrendt et al., Monatsschr. Kinderheilk., 136 (1998), 30-33). In particular on account of the demonstrated damage to teeth and dentition due to sucrose-containing beverages, sucrose-free instant teas have been developed that contain carbohydrates, such as glucose or maltodextrins, as carriers. However, the consumption of maltodextrin-containing instant tea products leads to an uncontrolled intake of cariogenic sugars (Koch und Wetzel, Schweiz. Monatsschr. Zahnmed., 105 (1995), 907-912).

Instant teas based on protein have also been developed. Although these instant teas are sugar-free, they likewise have a number of disadvantages. For example, it is not clear whether a continual supply of isolated proteins, especially between meals, can be considered desirable for health. Likewise, it is uncertain whether the supply of foreign proteins causes, for example, a risk of allergy in babies.

WO 2004/008870 discloses isomaltulose-containing instant beverage powders, in particular instant teas. The beverage powders described therein are mixtures of the various constituents, in particular of isomaltulose as sweetener, and various aroma substances. Some of the beverage powders described therein can be considered to be tooth-preserving. However, it is disadvantageous that the use of dry aroma substances, i.e. carrier-supported aroma substances in solid, i.e. dry, state still introduces a content of fermentable carbohydrates into dry aroma substances-containing powders, for example beverage powders.

The instant teas known according to the prior art, in particular those based on maltodextrins and proteins, are therefore subject to improvement with respect to their health-related non-objectionability and their acariogenicity.

The naturally occurring reducing disaccharide ketose, isomaltulose (6-O-α-D-glucopyranosyl-fructose; palatinose) has advantageous acariogenic properties, since isomaltulose is scarcely degraded by the human oral flora. Isomaltulose is usually produced from sucrose solutions that are either pure or obtained during sugar production, by transglucosidation of sucrose to form isomaltulose using viable or dead Protaminobacter rubrum cells or enzyme extracts prepared therefrom. Only the glucosidases of the human small bowel wall cleave palatinose and do so in a delayed fashion and the resulting degradation products, glucose and fructose, are absorbed. Compared to rapidly digestible carbohydrates, this results in a slow increase of the blood glucose. Unlike rapidly digestible, high-glycemic foods, isomaltulose requires no more than small amounts of insulin for its metabolization. Despite its favorable acariogenic properties, isomaltulose is rarely used as a sole sweetening agent in foods or beverages which is in contrast to other sugar substitutes, such as mannitol, sorbitol, and isomalt, or sweeteners, such as cyclamate. This is related mainly to the flavor of isomaltulose, in particular because of the substantially lower sweetening power as compared to sucrose. The sweetening power of 10% aqueous isomaltulose solutions is only approx. 0.4× the sweetening power of sugar. In addition, isomaltulose can form reversion and Maillard products.

Therefore, isomaltulose (palatinose) is mainly used as starting material for the production of isomalt, a virtually equimolar mixture of the diastereomers, 6-O-α-D-glucopyranosyl-D-sorbitol (1,6-GPS) and 1-O-α-D-glucopyranosyl-D-mannitol (1,1-GPM). Owing to its low sweetening power and ensuing flavor, isomaltulose, when used as a sweetening agent in food and/or beverages, is used chiefly in combination with other sugar substitutes and/or sweeteners. Isomaltulose is also used to some extent to cover the unpleasant taste of other foods. On account of its delayed degradation taking place no earlier than in the small bowels-region, isomaltulose is also used in specialized foods or beverages for athletes to maintain the oxidative metabolism.

It is known that even minute amounts of fermentable carbohydrates can lead to dental damage, in particular when beverages or foods are consumed repeatedly and frequently. Accordingly, even minute amounts of fermentable carbohydrates, such as are taken up, for example, by suckling babies, can cause substantial damage to the young teeth.

Based on this prior art, the technical problem is to provide means allowing to provide certain products intended for consumption by humans or animals, for example foods, luxury foods, pharmaceuticals or beverages, that are improved in terms of their stability on storage (shelf-life), flow properties, dosing properties, and development of aroma, and are enhanced in their tooth-preserving properties.

The present invention solves the technical problem underlying it by providing a dry aroma formulation, comprising at least one carrier-supported extract, whereby the carrier is a non-laxative, tooth-preserving sugar, namely isomaltulose and/or trehalose. Accordingly, the invention provides in particular for a dry aroma formulation, whereby the at least one extract is physically associated with the carrier, in particular is connected to the carrier in a mechanically inseparable fashion.

The dry aroma formulation according to the invention is characterized by its strong tooth-preserving effect. Moreover, the isomaltulose and the trehalose surprisingly show a high affinity for aroma substances and it is evident that the isomaltulose/extract compounds and trehalose/extract compounds thus obtained, i.e. the above-mentioned dry aroma formulations, are particularly stable on storage. They have good powder properties as regards their flow properties and dosing properties. Moreover, an influence of isomaltulose or trehalose that enhances the aromatic effect of the extracts is evident.

In the context of the present invention, an extract is taken to mean, in particular, an extract of plants and/or plant constituents that is produced, for example, by maceration, or percolation by means of water, aqueous solution, for example water/ethanol or ethanol, and, if applicable, subsequent evaporation of the extract thus obtained. An extract of this type can in particular be a tea extract, herb extract, fruit extract, an odor or flavor substance or an aroma, for example a fruit aroma. Obviously, the invention also includes under the term of extract synthetic nature-identical odor substances and/or flavor substances or aroma substances. However, in the context of the present invention, the term, extract, is also taken to mean a wine or spirit extract. In the context of the present invention, the term, extract, is also taken to mean, in particular, an aroma that is provided in the form of licorice aroma.

An advantageous embodiment of the invention relates to an above-mentioned dry aroma formulation, whereby this dry aroma formulation is characterized in that it contains not only one, but several different or many different extracts in carrier-supported form, namely in a form that is physically associated with isomaltulose and/or trehalose.

A particularly preferred embodiment provides the at least one extract to be physically associated with the isomaltulose and/or trehalose, whereby “physically associated” is taken to mean that the extract is physically connected to the carrier, that separation by means of physical forces, such as sedimentation or centrifugation, is not possible.

A particularly preferred embodiment provides that the at least one extract was attached or applied onto or to the carrier by means of a fluidized solids procedure, in particular in the fluidized layer agglomeration procedure, co-spray-drying procedure, by means of instantization, by means of extrusion, by means of freeze-drying or by means of co-agglomeration. One embodiment can provide for the isomaltulose and/or trehalose to be comminuted prior to the physical association.

Accordingly, the dry aroma formulation according to the invention can be produced, for example, by agglomeration, extrusion, spray drying or by means of instantization of the carrier and the extract. A particular embodiment can provide for the raw materials, in particular isomaltulose and/or trehalose, to be comminuted, and then to carry out an agglomeration, preferably by means of the fluidized solids procedure, whereby the comminuted isomaltulose and/or trehalose, the extract and the additives, if any, are agglomerated. The comminution of the isomaltulose and/or trehalose can be dispensable, if applicable. A further embodiment can provide for the raw materials, in particular isomaltulose and/or trehalose to be comminuted, and instantized with the extract and the additives, if any, under the effect of steam. The comminution of the isomaltulose or trehalose can be dispensable, if applicable. Obviously, it is also possible to subject the isomaltulose or trehalose and the extract to a wet granulation with subsequent drying and formulation, in particular screening, in order to obtain dry aroma formulations according to the invention in the form of powder or granulate.

According to the invention, it is preferred to use extracts comprising a particularly low fraction of fermentable carbohydrates. In the context of the present invention, fermentable carbohydrates is taken to mean, in particular, sucrose, glucose, and fructose as well as other carbohydrates that are metabolized by the human oral flora while generating organic acids.

A further particularly preferred embodiment provides for the fraction of fermentable carbohydrates in the at least one extract to be no more than 30% by weight, no more than 20% by weight, preferably no more than 10% by weight, no more than 5% by weight, preferably no more than 0.5% by weight, preferably no more than 0.1% by weight (all numbers stated in units of % by weight relate to the total dry substance of the extract).

A further particularly preferred embodiment provides for the content of fermentable carbohydrates in the dry aroma formulation to be no more than 30% by weight, no more than 20% by weight, no more than 10% by weight, no more than 5% by weight, no more than 0.5% by weight, no more than 0.1% by weight (each relative to the total dry substance of the dry aroma formulation).

A particularly preferred embodiment of the invention provides for the extracts to be depleted in the undesirable fermentable carbohydrates mentioned above in a procedural step that precedes the association with the carrier. This can be attained, for example, by chromatographic procedures, by selective hydration of the carbohydrates by means of suitable enzymes, in particular hydrogenases, or through the use of corresponding catalysts, by means of microbial degradation of the carbohydrates, for example by yeasts, or other procedures. The extracts thus depleted are then used jointly with isomaltulose for producing the dry aroma formulations according to the invention.

In a particularly preferred embodiment, the present invention provides for the dry aroma formulations according to the invention to consist solely of isomaltulose and/or trehalose and one or several of the extracts mentioned above. However, a further embodiment can provide for other substances, for example salts, in particular salts of organic or inorganic acids to be present aside from the isomaltulose and/or trehalose and one or several of the extracts. Moreover, for example, natural or synthetic dyes, antioxidants such as tocopherol or ascorbylpalmitate, flow aids such as silicon dioxide, stabilizers such as sodium sorbate or similar can also be used.

The invention provides, in particular for providing the isomaltulose and/or trehalose as the sole sugar, preferably as the sole body-providing sweetening agent, particularly preferred as the sole sweetening agent, present in the dry aroma formulation.

In the context of the present invention, the term, “sweetening agent”, is taken to mean substances that possess sweetening power and are added, for example, to foods or beverages in order to produce a sweet flavor. In the context of the present invention, the “sweetening agents” shall be subdivided as “sugars”, such as sucrose, glucose or fructose, that provide body and sweetening power, and as “sweetening means”, i.e. substances that are not sugars but still possess sweetening power, with the latter being further subdivided as “sugar substitutes”, i.e. sweetening agents possessing a body and a physiological caloric value in addition to their sweetening power (body-providing sweetening means), and as “intensive sweetening means”, i.e. substances that usually have very high sweetening power, but no body and usually no or little physiological caloric value.

Accordingly, in a particularly preferred embodiment, the isomaltulose and/or trehalose is provided to be the sole sweetening agent present in the dry aroma formulation, i.e. other than isomaltulose and/or trehalose, no sugars, no intensive sweetening means, and no sugar substitutes and/or sugar alcohols are present in the dry aroma formulation. However, the isomaltulose and/or trehalose can also be provided to be the sole body-providing sweetening agent present in the dry aroma formulation, i.e. no sugars, no sugar alcohols, and no sugar substitutes are present. A further embodiment can provide the isomaltulose and/or trehalose to be the sole sugar present in the dry aroma formulation, i.e. no other sugars are present.

The present invention solves the underlying technical problem also by providing above-mentioned dry aroma formulations, containing in a preferred embodiment, at least 40% by weight, at least 50% by weight, at least 60% by weight, at least 70% by weight, at least 80% by weight, preferably at least 90% by weight, preferably 90 to 99% by weight, in particular 95 to 99.9% by weight relative to the total quantity (total dry substance content of the dry aroma formulation) isomaltulose and/or trehalose as carrier, no more than 5% by weight, in particular 1 to 5% by weight, preferably 0.1 to 5% by weight, particularly preferably 0.1 to 1% by weight relative to the total quantity (total dry substance content of the dry aroma formulation) water, and 0.1% to 90% by weight, preferably 1 to 60% by weight, preferably 3 to 55%, especially 5 to 40% by weight, especially 0.1 to 10% by weight, preferably 0.1 to 5% by weight, in particular 0.1 to 2% by weight, preferably 0.1 to 1% by weight relative to the total quantity (total dry substance content of the dry aroma formulation) extract, for example from plants and/or plant parts.

In a preferred embodiment, the dry aroma formulation according to the present invention therefore preferably has 40 to 90% by weight, preferably 50 to 85% by weight, preferably 55 to 70% by weight of isomaltulose (based, in each case, on the dry substance of the dry aroma formulation).

In a further preferred embodiment, the dry aroma formulation according to the present invention has preferably 1 to 60% by weight, preferably 3 to 60% by weight, preferably 5 to 56% a way, in particular 3 to 55% by weight, preferably 10 to 30% by weight of extract (based, in each case, on the dry substance of the dry aroma formulation).

In a further preferred embodiment, the dry aroma formulations according to the present invention may additionally contain natural or synthetic aromas, preferably in an amount of 1 to 30% by weight and preferably of 2 to 30% by weight (based on the total dry substance of the dry aroma formulation).

Advantageously, the solid products produced through the use of the dry aroma formulations according to the invention, such as foods, luxury foods, pharmaceuticals, powders, etc., or ready-to-drink beverages, for example teas or tea-like products, do not lead to the known damage to teeth and dentition, since they, unlike instant tea beverages known according to the prior art, do not contain carbohydrates that can be fermented by the oral flora. Moreover, the use of isomaltulose and/or trehalose has technological advantages, in particular in the production of instant beverage powders. Since isomaltulose and/or trehalose are not hygroscopic, it is easily possible to produce non-clumping, free-flowing instant beverage powders in the form of powder or granulate. In addition, the use of isomaltulose and/or trehalose as carrier is very cost-effective, since isomaltulose can be produced cheaply from sucrose.

The use of isomaltulose and/or trehalose as carrier of dry aroma formulations is provided according to the invention, whereby the dry aroma formulation can be present in the form of a powder or agglomerated particles or as granulate. In the context of the present invention, a “carrier” or “carrier substance” is taken to mean a chemical substance serving as a substrate and/or scaffold for the substances eliciting the typical flavor-, odor-, and color-providing properties of products intended for consumption by humans or animals, such as foods, pharmaceuticals, luxury foods, beverages, for example teas or tea-like products.

Procedures such as, for example, ultrafiltration and reverse osmosis with subsequent spray-drying are used in the production of tea extracts, i.e. extracts of plant parts of the tea shrub, Camellia sinensis L. O. Kuntze, of the tea plants family. Tea extracts and/or other plant extracts comprise maximal water contents of 6% and maximal ash contents of 20%.

In a preferred development of the invention, the dry aroma formulation comprises a black tea extract. “Black tea” is taken to mean fermented tea, whose leaves are processed according to the customary procedures for the production of black tea, such as withering, rolling, fermenting, disintegrating and drying.

A further preferred development of the invention provides for the dry aroma formulation according to the invention to comprise an extract of Oolong tea. In the context of the present invention, “Oolong tea” is taken to mean a semi-fermented tea, whose leaves are fermented according to the customary procedures such as withering and rolling, whereby the fermentation is discontinued after approx. half of the usual time, and a drying is carried out.

A further preferred development of the invention relates to a dry aroma formulation according to the invention that contains a green tea extract. “Green tea” is taken to mean a non-fermented tea, whose leaves are blanched, rolled, and dried, and whose natural leaf pigment thus is largely preserved.

As a preferred development of the invention, an embodiment provides for the dry aroma formulations according to the invention to contain, in the form of an extract, natural or nature-identical odor substances and/or flavor substances carrier-supported on isomaltulose and/or trehalose for the purpose of aromatization. In the context of the invention, “odor substances or flavor substances” are taken to mean aroma, i.e. substances or mixtures of substances intended to convey a particular odor or flavor to foods, pharmaceuticals or luxury foods, or beverages, in particular tea powders. “Natural” aromatizing odor substances and flavor substances are substances or mixtures of substances that are obtained from natural sources, for example plants or plant parts, for example fruits or seeds, and, if applicable, are subjected to purification. Obviously, the odor substances and/or flavor substances used for aromatization can also be produced synthetically, i.e. synthetically produced nature-identical odor substances and/or flavor substances can also used for aromatization.

A further development of the invention provides for the dry aroma formulations according to the invention to be aromatized in that, for producing the dry aroma formulation, an extract is used that was obtained from a plant or plant constituent, in particular a tea, to which were added aroma-conveying fruit juices, odor- and/or flavor-conveying plants or plant parts or aroma-conveying potable spirits, for example whisky, arrack or rum, for the purpose of aromatization.

In a further preferred embodiment of the present invention, the extracts used according to the invention are herb extracts. In the context of the present invention, an herb extract is taken to mean an extract obtained from plants that are not a representative of the family of tea plants (Theaceae), and/or plant parts thereof, in particular leaves, leaf buds, stems, blossoms, seeds or roots, and that can be used, for example, for producing a ready-to-drink tea-like beverage.

The herb extracts according to the invention are preferably extracts of aloe (Aloes), aniseed, valerian (Valerianae), valerian root, broom (Sarothamni scoparii), henbane (Hyoscyami), moschatel (Visnagae), common bogbean (Trifolii fibrini), ipecacuanha (Ipecacuanhae), logania (Strychni), stinging nettle, blackberry leaves, cortex chinae (Chinae), condurango (Condurango), iron-containing apple (ferri pomati), ivy (Hederae helicis), gentian (Gentianae), strawberry leaves, fern (Filicis), frangula (Frangualae), fennel, pine needle (Pini), lady's mantle, silverweed, ginseng, Grindelia weed (Grindeliae), rosehip, yeast (Faecis), blueberry leaves, hibiscus blossoms, raspberry leaves, elder, hop vine, hop strobile (Strobuli lupuli), ginger, currant leaves, St. John's wort, calamus (Calami), camomile (Chamomillae), golden-seal (Hydrastis), holy thistle (Cardui benedicti), chestnuts (Castaneae), bitter-gourd (Colocynthidis), coriander, spearmint, Lapacho plant, lavender, lemon grass, linden blossoms, dandelion, lily of the valley (Convallariae), marjoram, mallow, malt (Malti), snake root, mate plant, balm, mistletoe (Visci albi), ergot (Secalis cornuti), opium (Opii), passion flower (Passiflorae), peppermint, peony, Seville bitter orange (Aurantii), ratanhia (Ratanhiae), marigold, rhubarb (Rhei), rosemary, Rooibos, echinacea (Echinaceae purpureae), Sagrada fluid (Cascarae sagradae), sage (Salviae), yarrow, primroses (Primulae), witten tree (Viburni prunifolii), Simaruba (Simarubae), narrow-leaved plantain, sweet clover (Meliloti), centaury (Centaurii), thyme (Thymi), deadly nightshade (Belladonnae), verbena, whitethorn (Crataegi), vitifoliae (Vitis viniferae), wormwood (Absinthii), hyssop, cinnamon and/or parts thereof. According to the invention, the extract is an extract of a single plant species. However, according to the invention it is also possible that the extracts are from at least two plant species.

A further preferred embodiment of the invention relates to aromatized herb extracts.

In a preferred development, the aromatized herb extract comprises, aside from the respective plant extract, additional natural or nature-identical odor substances or flavor substances. In a further preferred development of the invention, the aromatized herb extract comprises an extract obtained from plants or plant parts to which aroma-conveying fruit juices, for example, were added for aromatization prior to the extraction.

In a further preferred embodiment of the invention, the extracts according to the invention are fruit extracts. In the context of the present invention, a fruit extract is taken to mean a powder containing an extract that is obtained by customary methods from fruit and/or natural or nature-identical fruit aroma. In a preferred development, the fruit extract according to the invention contains an extract of fruit such as apples, pineapple, pears, oranges, grapefruit, limes, mango, passion fruit, currant, raspberry, blueberry, cherry, peaches, sea buckthorn berries, lemons, etc.

According to the invention, one embodiment of the invention provides the dry aroma formulation to contain 0.1% by weight to 5% by weight salts of organic or inorganic acids. Preferably, salts such as trisodiumcitrate or a phosphate such as K₂HPO₄ or KH₂PO₄ are used.

According to the invention, a preferred embodiment provides the dry aroma formulations according to the invention to contain flow aids. A “flow aid” or “flow agent” is taken to mean so-called free-flowing aids which effect the free-flowing of powders that are, for example, sticky or come to a stop. Preferably, the flow aids used according to the invention is silicon dioxide.

According to the invention, a preferred embodiment provides for the dry aroma formulations to contain natural and/or synthetic dyes. The natural dyes can be, for example, dyes of plant origin, such as carotinoids, flavonoids and anthocyans, dyes of animal origin such as cochineal, inorganic pigments such as titanium dioxide, iron oxide pigments and iron hydroxide pigments. Secondarily formed dyes such as the products of enzymatic browning, for example polyphenols, and products of non-enzymatic browning, such as melanoidines, can also be used as natural dyes. Moreover, according to the invention, it is provided that heating products such as caramel and sugar coloring are used as natural dyes. Moreover, synthetic dyes such as azo-, triphenylmethane, indigoid, xanthene, and quinoline compounds can be used as synthetic dyes for the dry aroma formulations according to the invention. Preferably, the synthetic dyes used according to the invention are water soluble to a special degree.

According to the invention, in a preferred embodiment, the dry aroma formulations according to the invention can, in addition, be fortified with natural or synthetic vitamins selected from the group consisting of vitamin A, vitamin B₁, vitamin B₂, vitamin B₃, vitamin B₅, vitamin B₆, vitamin B₁₂, vitamin B complex, vitamin C, vitamin D, vitamin E, vitamin F, and vitamin K. In addition, the dry aroma formulations according to the invention can contain minerals and trace elements. According to the invention, a preferred embodiment also provides for the dry aroma formulations according to the invention to contain intensive sweetening means, such as saccharine, saccharine-Na, saccharine-K, saccharine-Ca, sodium cyclamate, calcium cyclamate, acesulfame-K, aspartame, dulcin, stevioside, and neohesperidine-dihydrochalcone.

Obviously, the present invention also relates to solid or liquid products, in particular for consumption by humans or animals produced by means of the above-mentioned dry aroma formulations, in particular foods, luxury foods, animal feeds, pharmaceuticals, powders, in particular beverage powders, preferably instant beverage powders and beverages as such. Products of this type can be provided, for example, in the form of compressed products or pellets.

The present invention also relates to methods for producing a dry aroma formulation according to the invention, whereby the at least one extract is made to be physically associated with the carrier by physically contacting the carrier and the at least one extract, for example by means of a fluidized bed procedure, in particular a fluidized bed agglomeration procedure, an extrusion procedure, a co-spray-drying procedure, an instantization procedure or a freeze-drying procedure or a co-agglomeration procedure, and a product is obtained that contains the at least one extract in a carrier-supported fashion, in particular comprises at least one extract that is physically associated with the carrier.

The foods, pharmaceuticals, luxury foods, beverages, in particular instant beverage powders and tea beverages or tea-like beverages such as herb tea or fruit tea produced on the basis of the dry aroma formulation according to the invention, are advantageously characterized in that they, unlike known carbohydrate-containing instant tea beverages according to the prior art, when consumed do not, or maximally for a short time, lead to a lowering of the pH inside the oral cavity to the significant range for tooth damage of below pH 5.7, as determined by methods of plaque pH telemetry. Intraoral plaque pH telemetry (Graf und Mühlemann, J. Dent. Res., 44 (1965), 1039; Graf und Mühlemann, Helv. Odont. Acta, 10 (1966), 94) is the sole in-vivo method that provides for the rapid and reliable measurement of the H⁺ ion concentration under an undisturbed plaque at the level of the enamel surface of the teeth. Accordingly, this method allows the pH value or its change in the plaque-covered interdental space and in the whole saliva to be monitored continuously during and after undisturbed intake of beverages or foods. According to the pH telemetric determinations carried out, the instant beverage powders based on isomaltulose and/or trehalose that are provided according to the invention as carrier substance can be classified as tooth-preserving or, in the context of tooth-preserving products, as tooth-friendly.

And lastly, a further object of the present invention is the use of isomaltulose and/or trehalose as, in particular, tooth-preserving and/or acariogenic carrier for extracts of a dry aroma formulation, in particular for producing dry aroma.

Further advantageous embodiments of the invention can be taken from the subclaims.

The invention is explained in more detail by means of the following examples:

### EXAMPLES OF ISOMALTULOSE DRY AROMA FORMULATIONS

### Example 1

The dry aroma formulation was prepared from the following components:

Formulation of Isomaltulose Orange Dry Aroma

| | |
|---|---|
| isomaltulose | 58.0% |
| orange aroma extract | 30.0% |
| natural orange aroma | 12.0% |
| Total | 100.0% |

### Example 2

The dry aroma formulation was prepared from the following components:

Formulation of Isomaltulose Lemon Dry Aroma

| | |
|---|---|
| isomaltulose | 59.0% |
| lemon aroma extract | 10.0% |
| natural lemon aroma | 30.0% |
| citric acid | 1.0% |
| Total | 100.0% |

### Example 3

The dry aroma formulation was prepared from the following components:

Formulation of Isomaltulose Vanilla Dry Aroma

| | |
|---|---|
| isomaltulose | 40.0% |
| gum Arabic | 5.50% |
| silica | 1.0% |
| vanilla aroma extract | 53.5% |
| Total | 100.0% |

### Example 4

The dry aroma formulation was prepared from the following components:

Formulation of Isomaltulose Caramel Dry Aroma

| | |
|---|---|
| isomaltulose | 81.50% |
| aroma extracts | 3.0% |
| aromas identical with natural ones | 5.25% |
| natural aroma | 10.0% |
| maltol | 0.25% |
| Total | 100.0% |

### Example 5

The dry aroma formulation was prepared from the following components:

Formulation of Isomaltulose Rooibos Dry Aroma

| | |
|---|---|
| isomaltulose | 52.50% |
| rooibos extract | 46.50% |
| silica | 1.0% |
| Total | 100.0% |

### Example 6

The dry aroma formulation was prepared from the following components:

Formulation of Isomaltulose Fenchel Dry Aroma

| | |
|---|---|
| Isomaltulose | 44.40% |
| fenchel extract | 55.60% |
| total | 100.0% |

### Example 7

The dry aroma formulation was prepared from the following components:

Formulation of Isomaltulose Peppermint Dry Aroma

| | |
|---|---|
| isomaltulose | 44.40% |
| peppermint extract | 55.60% |
| total | 100.0% |

### Example 8

The dry aroma formulation was prepared from the following components:

Formulation of Isomaltulose Black Tea Dry Aroma

| | |
|---|---|
| isomaltulose | 85.0% |
| black tea extract | 15.0% |
| Total | 100.0% |

1-29. (canceled)

30. A dry aroma formulation, comprising at least one carrier-supported extract, wherein the carrier is a tooth-preserving, non-laxative sugar comprising isomaltulose, wherein the extract is physically associated with the carrier.

31. The dry aroma formulation according to claim 30, wherein the extract is physically associated with the carrier by one or more processes selected from the group consisting of fluidized bed technique, extrusion, co-spray-drying, co-agglomeration, instantization, and combinations thereof.

32. The dry aroma formulation according to claim 30, wherein a fermentable carbohydrate content of the extract is less than or equal to about 20% by weight relative to the total dry weight of the extract.

33. The dry aroma formulation according to claim 30, wherein a fermentable carbohydrate content of the extract is less than or equal to about 0.5% by weight relative to the total dry weight of the extract.

34. The dry aroma formulation according to claim 30, wherein a fermentable carbohydrate content of the dry aroma formulation is less than or equal to about 20% by weight relative to the total dry weight of the dry aroma formulation.

35. The dry aroma formulation according to claim 30, wherein a fermentable carbohydrate content of the dry aroma formulation is less than or equal to about 0.5% by weight relative to the total dry weight of the dry aroma formulation.

36. The dry aroma formulation according to claim 30, wherein the extract is selected from the group consisting of a tea extract, an herb extract, a fruit extract, an odor substance, a flavor substance, an aroma, and combinations thereof.

37. The dry aroma formulation according to claim 30, comprising greater than or equal to about 40% by weight of the carrier comprising isomaltulose relative to the total dry weight of the dry aroma composition; less than or equal to about 5% by weight of water relative to the total dry weight of the dry aroma formulation; and about 0.1% to about 5% by weight of the extract relative to the total dry weight of the dry aroma formulation.

38. The dry aroma formulation according to claim 30, wherein the extract comprises an extract obtained from one or more parts of a tea plant.

39. The dry aroma formulation according to claim 38, wherein the extract is selected from the group consisting of a black tea, a green tea, Oolong tea, and combinations thereof.

40. The dry aroma formulation according to claim 30, wherein the extract is a natural or nature-based odor substance and/or flavor substance.

41. The dry aroma formulation according to claim 30, wherein the extract is obtained from a plant, and wherein a component is added to the extract during its production for the purpose of aromatization, where the component is selected from the group consisting of an aroma-conveying fruit juice, an odor- and/or flavor-conveying plant or plant part, an aroma-conveying potable spirit, and combinations thereof.

42. The dry aroma formulation according to claim 30, wherein the extract is obtained from the group consisting of aloe, aniseed, valerian, valerian root, broom, henbane, moschatel, common bogbean, ipecacuanha, logania, stinging nettle, blackberry leaves, cortex chinea, condurango, iron-containing apple, ivy, gentian, strawberry leaves, fern, frangula, fennel, pine needle, lady's mantle, silverweed, ginseng, Grindelia weed, rosehip, yeast, blueberry leaves, hibiscus blossoms, raspberry leaves, elder, hop vine, hop strobile, ginger, currant leaves, St. John's wort, calamus, camomile, golden-strobile, ginger, currant leaves, St. John's wort, calamus, camomile, golden-seal, holy thistle, chestnuts, bitter-gourd, coriander, spearmint, Lapacho plant, lavender, lemon grass, linden blossoms, dandelion, lily of the valley, marjoram, mallow, malt, snake root, mate plant, balm, mistletoe, ergot, opium, passion flower, peppermint, peony, Seville bitter orange, ratanhia, marigold, rhubarb, rosemary, Rooibos, echinacea, Sagrada fluid, sage, yarrow, primroses, witten tree, Simaruba, narrow-leaved plantain, sweet clover, centaury, thyme, deadly nightshade, verbena, whitethorn, vitifoliae, wormwood, hyssop, cinnamon, and/or parts and combinations thereof.

43. The dry aroma formulation according to claim 30, wherein the dry aroma formulation comprises an extract obtained from a fruit.

44. The dry aroma formulation according to claim 43, wherein the fruit extract is obtained from a fruit selected from the group consisting of: apples, pineapple, pears, oranges, grapefruit, limes, mango, passion fruit, currant, raspberry, blueberry, cherry, peaches, sea buckthorn berries, lemons, and combinations thereof.

45. The dry aroma formulation according to claim 30, wherein the dry aroma formulation comprises about 0.1% by weight to about 5% by weight of an additional agent relative to a total dry weight of the dry aroma formulation, wherein the additional agent is selected from the group consisting of salts of organic and/or inorganic acids, flow aids, antioxidants, stabilizers, and combinations thereof.

46. The dry aroma formulation according to claim 45, wherein the additional agent comprises a salt selected from a trisodiumcitrate and/or a phosphate.

47. The dry aroma formulation according to claim 45, wherein the additional agent comprises an antioxidant selected from ascorbylpalmitate and/or alpha-tocopherol.

48. The dry aroma formulation according to claim 45, wherein the additional agent comprises a flow aid comprising silicon dioxide.

49. The dry aroma formulation according to claim 30, wherein the dry aroma formulation further comprises a natural dye and/or a synthetic dye.

50. The dry aroma formulation according to claim 49, wherein the natural dye is selected from the group consisting of a dye of plant origin, a dye of animal origin, an inorganic pigment, a product of enzymatic browning, a product of non-enzymatic browning, a carbohydrate heating product, and combinations thereof.

51. The dry aroma formulation according to claim 49, wherein the synthetic dye is selected from the group consisting of an azo compound, a triphenylmethane compound, an indigoid compound, a xanthene compound, a quinoline compound and combinations thereof.

52. The dry aroma formulation according to claim 30, wherein the dry aroma formulation further comprises minerals and/or trace elements.

53. The dry aroma formulation according to claim 30, wherein the dry aroma formulation further comprises at least one intensive sweetening agent.

54. The dry aroma formulation according to claim 53, wherein the intensive sweetening agent is selected from the group consisting of saccharine, saccharine-Na, saccharine-K, saccharine-Ca, sodium cyclamate, calcium cyclamate, acesulfame-K, aspartame, dulcin, stevioside, neohesperidine-dihydrochalcone, and combinations thereof.

55. A product containing a dry aroma formulation according to claim 30, wherein the product is a food, animal feed, pharmaceutical, beverage, beverage powder, tablet, powder, pellet or luxury food.

56. A method for producing a dry aroma formulation comprising physically associating a carrier with at least one extract by a process selected from the group consisting of extrusion, fluidized bed technique, co-agglomeration, co-spray-drying, instantization, and combinations thereof, to form a carrier-supported extract, wherein the carrier comprises a tooth-preserving, non-laxative sugar comprising isomaltulose and/or trehalose.

57. A tooth-preserving carrier for one or more extracts in a dry flavoring formulation, wherein the carrier comprises isomaltulose.
